(19) United States
(12) Patent Application Publication
(10) Pub. No.: US 2013/0136237 A1
(43) Pub. Date: May 30, 2013

(54) X-RAY TUBE HIGH VOLTAGE SENSING RESISTOR

(71) Applicant: Moxtek, Inc., Orem, UT (US)

(72) Inventor: Dongbing Wang, Lathrop, CA (US)

(73) Assignee: Moxtek, Inc., Orem, UT (US)

(21) Appl. No.: 13/744,193

(22) Filed: Jan. 17, 2013

Related U.S. Application Data
(63) Continuation-in-part of application No. PCT/US2011/044168, filed on Jul. 15, 2011.
Application No. PCT/US2011/044168 is a continuation of application No. 12/890,325, filed on Sep. 24, 2010.
(60) Provisional application No. 61/610,018, filed on Mar. 13, 2012.

(51) Int. Cl. H05G 1/26

(52) U.S. Cl. CPC H05G 1/265
USPC 378/121

(57) ABSTRACT

A high voltage sensing resistor disposed on a cylinder that at least partially surrounds an evacuated enclosure of an x-ray tube.

### CLAIM OF PRIORITY

Priority is claimed to U.S. Provisional Patent Application Ser. No. 61/610,018, filed on Mar. 13, 2012; which is hereby incorporated herein by reference in its entirety.

This is a continuation-in-part of International Patent Application Serial Number PCT/US2011/044168, filed on Jul. 15, 2011; which claims priority to U.S. patent application Ser. No. 12/890,325, filed Sep. 24, 2012, and U.S. Provisional Patent Application Ser. No. 61/420,401, filed Dec. 7, 2010; which are hereby incorporated herein by reference in their entirety.

### BACKGROUND

A desirable characteristic of x-ray sources, especially portable x-ray sources, is small size. An x-ray source can be comprised of an x-ray tube and a power supply. An x-ray source can have a high voltage sensing resistor used in the power supply circuit for sensing the tube voltage. The high voltage sensing resistor, due to a very high voltage across the x-ray tube, such as around 10 to 200 kilovolts, can require a very high resistance, such as around 10 mega ohms to 100 giga ohms for example. The high voltage sensing resistor can be a surface mount resistor and can be relatively large compared to other resistors. For example, resistor dimension can be around 12 mm×50 mm×1 mm in some power supplies. Especially in miniature and portable x-ray tubes, the size of this resistor can be an undesirable limiting factor in reduction of size of a power supply for these x-ray tubes.

### SUMMARY

It has been recognized that it would be advantageous to have a smaller, more compact, x-ray source. The present invention is directed towards a smaller, more compact, x-ray source.

To save space, the high voltage sensing resistor can be disposed over an x-ray tube cylinder. Thus by having the high voltage sensing resistor over the x-ray tube cylinder, space required by this resistor can be minimized, allowing for a more compact power supply of the x-ray source.

A method for sensing a voltage across an x-ray tube can comprise painting electrically insulative material on a surface of an electrically insulative cylinder, the insulative material comprising a first resistor, the insulative cylinder surrounding at least a portion of an evacuated chamber of an x-ray tube. The first resistor can be connected to a second resistor at one end and to either a cathode or an anode of the x-ray tube at an opposing end. A voltage across the second resistor can be measured. A voltage across the x-ray tube can be calculated by

$$V = \frac{{V}_{2} * ( {r}_{1} + {r}_{2} )}{{r}_{2}} ,$$

wherein V is a voltage across the x-ray tube, V2 is a voltage across the second resistor, r1 is a resistance of the first resistor, and r2 is a resistance of the second resistor.

### BRIEF DESCRIPTION OF THE DRAWINGS

FIG. 1 is a schematic cross-sectional side view of an electrically insulative cylinder with a first resistor disposed on or over a surface of the cylinder, and circumscribing the cylinder, in accordance with an embodiment of the present invention;

FIG. 2 is a schematic cross-sectional side view of an electrically insulative cylinder with a first resistor disposed on or over a surface of the cylinder, and circumscribing the cylinder, and a second resistor electrically connected to the first resistor and disposed on or over the surface of the cylinder, in accordance with an embodiment of the present invention;

FIG. 3 is a schematic cross-sectional side view of an electrically insulative cylinder and a first resistor disposed on or over the cylinder in a zig-zag shaped pattern, in accordance with an embodiment of the present invention;

FIG. 4 is a schematic cross-sectional end view, perpendicular to the side views of FIGS. 1-3, of an x-ray tube cylinder 41, which is surrounded at least partially by a second electrically insulative cylinder 42, in accordance with an embodiment of the present invention;

FIG. 5 is a schematic cross-sectional end view, perpendicular to the side views of FIGS. 1-3, of an x-ray tube cylinder 51, in accordance with an embodiment of the present invention.

### DEFINITIONS

As used herein, the term “evacuated chamber” means an enclosure having a sufficiently high internal vacuum to allow operation as an x-ray tube.
As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

### DETAILED DESCRIPTION

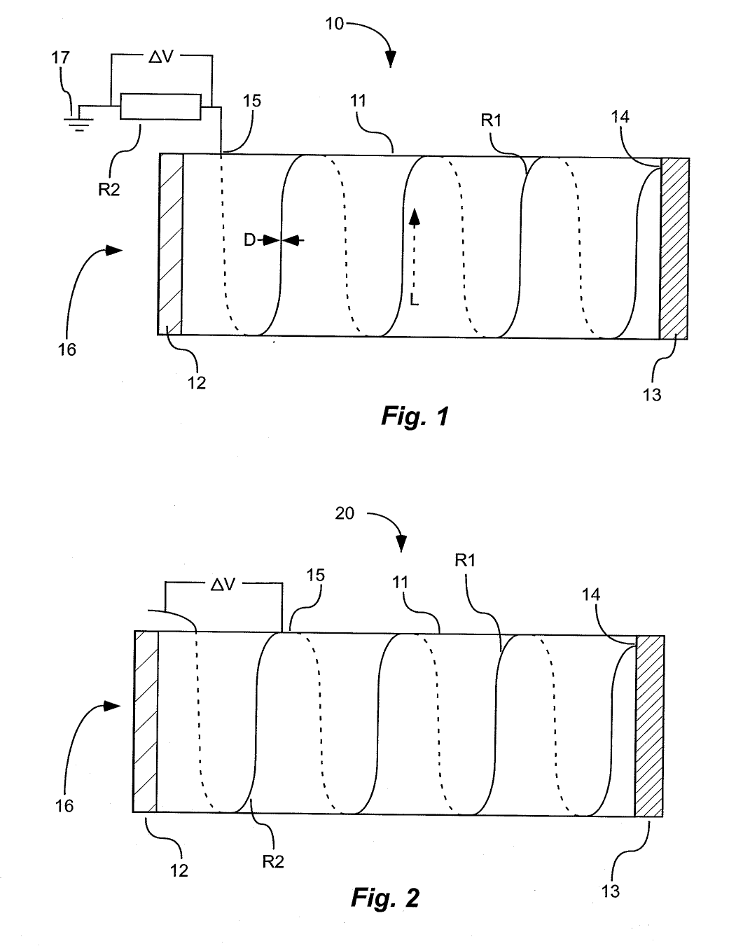

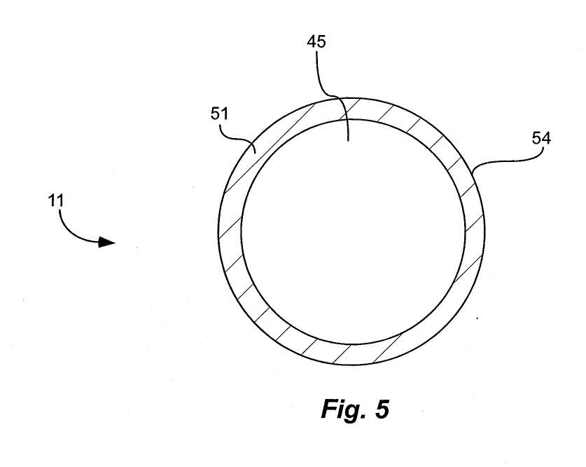

As illustrated in FIGS. 1-2, x-ray sources 10 and 20 are shown comprising an x-ray tube 16, a first resistor R1 and a second resistor R2 electrically connected in series. The x-ray tube 16 comprises an evacuated chamber, an anode 12 disposed at one end of the evacuated chamber (see 45 in FIGS. 4 and 5), and a cathode 13 disposed at an opposing end of the evacuated chamber 45 from the anode 12. An electrically insulative cylinder 11 can at least partially surround the evacuated chamber 45. The insulative cylinder 11 can circumscribe a portion of the evacuated chamber 45.

The first resistor R1 can comprise a line of electrically insulative material. The “line” can be defined as having a length L and a diameter D and wherein the length L is (1) at least 5 times longer than the diameter D in one embodiment, (2) at least 10 times longer than the diameter D in another embodiment, or at least 100 times longer than the diameter D in another embodiment.

The first resistor R1 can be disposed directly on a surface of the insulative cylinder 11 in one embodiment, or disposed over a surface of the insulative cylinder 11 in another embodiment. The first resistor R1 can be a dielectric ink painted on the surface of the insulative cylinder 11 in one embodiment.

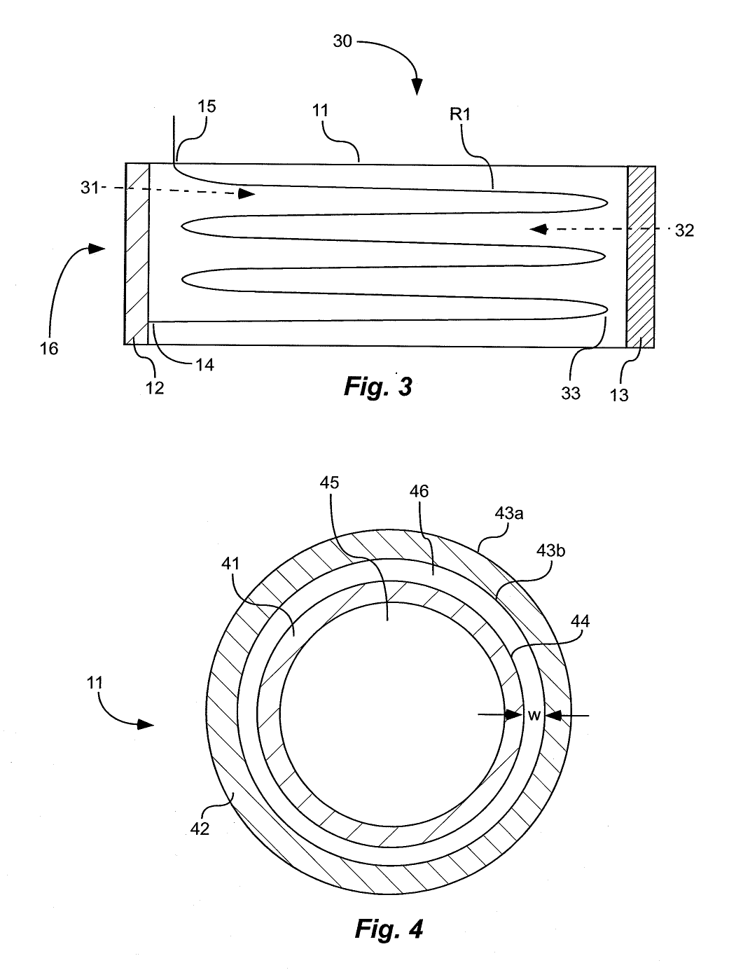

The first resistor R1 can be electrically connected to either the anode 12 or the cathode 13 at one end 14; and configured to be electrically connected to an external circuit at an opposing end 15. In FIGS. 1 and 2, the first resistor R1 is electrically connected to the cathode 13 at one end 14 but in FIG. 3, the first resistor R1 is electrically connected to the anode 12 at one end 14, thus showing that the first resistor R1 can be electrically connected to either the anode 12 or the cathode 13 at one end 14 in the various embodiments described herein. Normally, the first resistor R1 will be electrically connected to the cathode 13 at one end 14, in order to allow voltage measurement at a lower voltage at the opposite end 15.

The first resistor R1 can have a very large resistance, in order to allow sensing very large x-ray tube voltages, such as tens of kilovolts. The resistance across the first resistor, from one end 14 to the opposite end 15, can be at least 1 mega ohm in one embodiment, at least 100 mega ohms in another embodiment, or at least 1 giga ohm in another embodiment.

As shown in FIGS. 1-2, a second resistor R2 can be connected in series with the first resistor R1. The second resistor R2 can comprise part of the external circuit. The second resistor R2 can have a resistance r2 that is much smaller than a resistance r1 of the first resistor R1. The second resistor R2 can have a resistance of at least 1 kilo ohm less than a resistance of the first resistor R1 in one embodiment, a resistance of at least 10 mega ohms less than a resistance of the first resistor R1 in another embodiment, or a resistance of at least 1 giga ohm less than a resistance of the first resistor R1 in another embodiment. The resistance of the first resistor can be is at least 1000 times higher than the resistance of the second resistor in one embodiment, or at least 10,000 times higher than the resistance of the second resistor in another embodiment.

This large resistance difference, between the first resistor R1 and the second resistor, can allow for easier determination of overall tube voltage. It can be difficult to directly measure a voltage differential of tens of kilovolts. A voltage measurement device ΔV can be connected across the second resistor R2 and can be configured to measure a voltage across the second resistor R2. Having a second resistor R2 with a resistance r2 that is substantially smaller than a resistance of the first resistor R1 allows calculation of tube voltage by measurement of a voltage that is much smaller than tube voltage. X-ray tube voltage may be determined by the formula:

$$V = \frac{{V}_{2} * ( {r}_{1} + {r}_{2} )}{{r}_{2}} ,$$

wherein v is a voltage across the x-ray tube, V2 is a voltage across the second resistor, r1 is a resistance of the first resistor, and r2 is a resistance of the second resistor

In one embodiment, the second resistor R2 can be connected to ground 17 at one end and to the first resistor R1 at an opposing end. The external circuit can consist of the second resistor R2, ground 17, and the voltage measurement device ΔV.

As shown in FIG. 1, the second resistor R2 can be disposed partially or totally away from the insulative cylinder 11, such that the second resistor R2 either does not touch the insulative cylinder 11 or the second resistor R2 only partially touches the insulative cylinder 11. As shown in FIG. 2, the second resistor can be a line of electrically insulative material disposed on the insulative cylinder. The second resistor R2 can be a dielectric ink painted on the surface of the insulative cylinder 11.

The first resistor R1 can be any electrically insulative material that will provide the high resistance required for high voltage applications. In one embodiment, the first resistor R1 and/or the second resistor R2 can comprise beryllium oxide (BeO), also known as beryllia. Beryllium oxide can be beneficial due to its high thermal conductivity, thus providing a more uniform temperature gradient across the resistor.

As shown in FIGS. 1-2, the first resistor R1 can wrap around a circumference of the cylinder, or circumscribe the cylinder, multiple times. The first resistor can wrap around a circumference of the cylinder, or circumscribe the cylinder 11, at least three times in one embodiment, at least five times in another embodiment, at least fifteen times in another embodiment, or at least twenty times in another embodiment.

The first resistor R1 need not wrap around the cylinder but can be disposed in any desired shape on the cylinder, as long as the desired resistance from one end to another is achieved. As shown in FIG. 3, the first resistor can zig zag back and forth across a surface of the cylinder 11. The first resistor can extends in a first direction 31, then reverse in a second direction 32 substantially opposite of the first direction 31, then reverse and extend again in the first direction 31, and repeat this reversal of direction 33 at least three more times.

As shown in FIG. 4, the insulative cylinder can comprise a first electrically insulative cylinder 41 and a second electrically insulative cylinder 42. The first insulative cylinder 41 can form at least a portion of the evacuated chamber 45 along with the anode 12 and the cathode 13. The first insulative cylinder 41, the anode 12, and the cathode 13, can form the boundaries of and encompass the evacuated chamber 45. The second insulative cylinder 42 can at least partially surround the first insulative cylinder 41.

The line of insulative material can be disposed on an outer surface 44 of the first insulative cylinder 41, an outer surface 43a of the second insulative cylinder 42, or an inner surface 43b of the second insulative cylinder 42. The first resistor R1 and/or the second resistor R2 can be a line of electrically insulative dielectric ink painted on an outer surface 44 of the first insulative cylinder 41, an outer surface 43a of the second insulative cylinder 42, or an inner surface 43b of the second insulative cylinder 42.

There may be a gap 46 between the first insulative cylinder 41 and the second insulative cylinder 42. This gap 46 may be needed for ease of manufacturing or to allow insertion of insulation between the two cylinders. The gap can have a width w of between 0.5 millimeters and 5 millimeters in one embodiment. Electrically insulative potting material can substantially or completely fill the gap in one embodiment.

As shown in FIG. 5, the electrically insulative cylinder 11 can comprise a single electrically insulative cylinder 51. The single insulative cylinder 51 can form at least a portion of the evacuated chamber 45 along with the anode 12 and the cathode 13. The single insulative cylinder 51, the anode 12, and the cathode 13, can form the boundaries of and can encompass the evacuated chamber 45. The first resistor R1 can be disposed on an outer surface 54 of the single insulative cylinder. The first resistor R1 can be an electrically insulative dielectric ink painted on the outer surface of the single insulative cylinder 54.

A single electrically insulative cylinder 51, as shown in FIG. 5, may be better for improved electron beam shaping within the x-ray tube 16, for decreased part cost, and for smaller size. Two cylinders, as shown in FIG. 4, may be better for ease of manufacturing.

MicroPen Technologies of Honeoye Falls, N.Y. has a technology for applying a thin line of electrically insulative material on the surface of a cylindrical object. Micropen's technology, or other technology for tracing a fine line of resistive material on a surface of a cylinder, may be used for applying the first resistor R1 and/or the second resistor R2 on a surface of the electrically insulative cylinder 11. The insulative cylinder 11 can be turned on a lathe-like tool and the insulative material can be painted in a line on the exterior of the cylinder 11.

One method for sensing a voltage across an x-ray tube 16 includes painting electrically insulative material on a surface of an electrically insulative cylinder 11. The insulative material can comprise a first resistor R1. The insulative cylinder 11 can surround at least a portion of an evacuated chamber of an x-ray tube 16.

The method can further comprise connecting the first resistor R1 to the second resistor R2 at one end 14 and to either a cathode 13 or an anode 12 of the x-ray tube 16 at an opposing end 15, and connecting an opposing end of the second resistor to ground. Then a voltage across the second resistor R2 can be measured. A voltage V can then be calculated across the x-ray tube by:

$$V = \frac{{V}_{2} * ( {r}_{1} + {r}_{2} )}{{r}_{2}} ,$$

wherein V is a voltage across the x-ray tube, V2 is a voltage across the second resistor, r1 is a resistance of the first resistor, and r2 is a resistance of the second resistor.

What is claimed is:

1. An x-ray source comprising:
a. an electrically insulative cylinder;
b. an x-ray tube comprising:
i. an evacuated chamber;
ii. an anode disposed at one end of the evacuated chamber;
iii. a cathode disposed at an opposite end of the evacuated chamber from the anode;
c. the insulative cylinder circumscribing a portion of the evacuated chamber;
d. a first resistor and a second resistor electrically connected in series;
e. the first resistor:
i. comprising a line of electrically insulative dielectric ink painted on a surface of the insulative cylinder;
ii. having a resistance of at least 10 mega ohms;
iii. including a first end attached to either the anode or the cathode; and
iv. including a second end electrically connected to a first end of the second resistor;
f. a resistance of the first resistor is at least 100 times higher than a resistance of the second resistor; and
g. a voltage measurement device connected across the second resistor and configured to measure a voltage across the second resistor.

2. The x-ray source of claim 1, wherein the first resistor wraps around a circumference of the cylinder at least five times.

3. The x-ray source of claim 1, wherein:
a. the electrically insulative cylinder comprises a single electrically insulative cylinder; and
b. the single insulative cylinder forms at least a portion of the evacuated chamber along with the anode and the cathode.

4. The x-ray source of claim 1, wherein the first resistor extends in a first direction, then reverses in a second direction substantially opposite of the first direction, then reverses and extends again in the first direction, and repeats this reversal of direction at least three more times.

5. An x-ray source comprising:
a. an electrically insulative cylinder;
b. an x-ray tube comprising:
i. an evacuated chamber;
ii. an anode disposed at one end of the evacuated chamber;
iii. a cathode disposed at an opposing end of the evacuated chamber from the anode;
c. the insulative cylinder at least partially surrounding the evacuated chamber; and
d. a first resistor:
i. comprising a line of electrically insulative material, having a length and a diameter and wherein the length is at least 10 times longer than the diameter;
ii. disposed directly on a surface of the insulative cylinder;
iii. electrically connected to either the anode or the cathode at one end; and
iv. configured to be electrically connected to an external circuit at an opposing end.

6. The x-ray source of claim 5, wherein:
a. the insulative cylinder comprises a first electrically insulative cylinder and a second electrically insulative cylinder;
b. the first insulative cylinder forms at least a portion of the evacuated chamber along with the anode and the cathode;
c. the second insulative cylinder at least partially surrounds the first insulative cylinder; and
d. the line of insulative material is disposed on a surface of the second insulative cylinder.

7. The x-ray source of claim 6, wherein:
a. a gap between the first insulative cylinder and the second insulative cylinder is between 0.5 millimeters and 5 millimeters; and
b. electrically insulative potting material substantially fills the gap.

8. The x-ray source of claim 6, wherein the first resistor is a dielectric ink painted on the surface of the second insulative cylinder.

9. The x-ray source of claim 8, wherein the line of insulative material is disposed on an inside surface of the second insulative cylinder.

10. The x-ray source of claim 8, wherein the line of insulative material is disposed on an outside surface of the second insulative cylinder.

11. The x-ray source of claim 5, wherein a resistance across the first resistor from one end to the other end is at least 10 mega ohms.

12. The x-ray source of claim 5, further comprising:
a. a second resistor connected in series with the first resistor;
b. the second resistor having a resistance of at least 1 kiloohm less than a resistance of the first resistor; and
c. a voltage measurement device connected across the second resistor and configured to measure a voltage across the second resistor.

13. The x-ray source of claim 12, wherein the second resistor is a line of electrically insulative material disposed on the insulative cylinder.

14. The x-ray source of claim 12, wherein the resistance of the first resistor is at least 1000 times higher than the resistance of the second resistor.

15. The x-ray source of claim 5, wherein the first resistor wraps around a circumference of the cylinder at least five times.

16. The x-ray source of claim 5, wherein the first resistor extends in a first direction, then reverses in a second direction substantially opposite of the first direction, then reverses and extends again in the first direction, and repeats this reversal of direction at least three more times.

17. The x-ray source of claim 5, wherein:
a. the electrically insulative cylinder comprises a single electrically insulative cylinder;
b. the single insulative cylinder forms at least a portion of the evacuated chamber along with the anode and the cathode; and
c. the first resistor is disposed on an outer surface of the single insulative cylinder.

18. The x-ray source of claim 17, wherein the first resistor is a dielectric ink painted on the outer surface of the single insulative cylinder.

19. The x-ray source of claim 5, wherein the first resistor comprises beryllium oxide.

20. A method for sensing a voltage across an x-ray tube, the method comprising:
a. painting electrically insulative material on a surface of an electrically insulative cylinder, the insulative material comprising a first resistor, the insulative cylinder surrounding at least a portion of an evacuated chamber of the x-ray tube;
b. connecting the first resistor to a second resistor at one end and to either a cathode or an anode of the x-ray tube at an opposing end;
c. connecting an opposing end of the second resistor to ground;
d. measuring a voltage across the second resistor; and
e. calculating a voltage across the x-ray tube by
$$V = \frac{{V}_{2} * ( {r}_{1} + {r}_{2} )}{{r}_{2}} ,$$
wherein V is a voltage across the x-ray tube, V2 is a voltage across the second resistor, r1 is a resistance of the first resistor, and r2 is a resistance of the second resistor.
